(19) United States
(12) Patent Application Publication
(10) Pub. No.: US 2009/0054081 A1
(43) Pub. Date: Feb. 26, 2009

(54) SYSTEM AND METHOD FOR LOCATING POSITIONS OF MEMBERS OF VIRTUAL GROUPS

(75) Inventor: I-FEI TSAI, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/124,166

(22) Filed: May 21, 2008

(30) Foreign Application Priority Data
Aug. 24, 2007 (CN) 200710201461.5

(51) Int. Cl. H04Q 7/20

(52) U.S. Cl. 455/456.1

(57) ABSTRACT

A method for locating positions of members of virtual groups includes the following steps of: establishing multiple virtual groups for a user to join in; acquiring position information of each member in each of the virtual groups; storing the position information of each member in each of the virtual groups in a storage; receiving requests for viewing position information of members in a designated virtual group from terminal devices; obtaining the position information of the members in the designated virtual group from the storage according to the requests, and constructing a positional map according to the position information; and transmitting the positional map to the terminal devices of the members in the designated virtual group.

### BACKGROUND

1. Field of the Invention

The present invention relates to systems and methods for position-based services, and particularly to a system and method for locating positions of members of virtual groups.

2. Description of related art

In the field of mobile telephony, the Global System for Mobile communications (GSM) is the most popular standard for mobile phones in the world. A promoter of GSM, the GSM Association, estimates that 82% of the global mobile market uses the GSM standard. GSM's ubiquity makes international roaming very common for mobile phone users.

In recent years, the Global Positioning System (GPS) is widely used for locating positions of objects. Different electronic apparatuses use GPS. For example, drivers may search for a route to a destination through a map provided by GPS installed in their car. For another example, smart phones having GPS are helpful for users to locate their positions, or to determine how to reach their destination. However, the electronic apparatus having GPS can only reveal its own position or fixed positions of landmarks etc, and not respective positions of multiple objects at the same time.

Accordingly, what is needed is a system and method for locating multiple members in a preset virtual group, so as to provide information such as positional maps, for the members to share with each other.

### SUMMARY

A system for locating positions of members of virtual groups is provided. The system is installed in a server connected with a plurality of terminal devices. The server includes a virtual group setting module, an auto updating module, a storage, a transmitting module, and a map constructing module. The virtual group setting module is configured for establishing multiple virtual groups for a user to join in. The auto updating module is configured for acquiring position information of each member in each of the virtual groups, and storing the position information in a storage. The transmitting module is configured for receiving requests for viewing position information of members in a designated virtual group from a terminal device. The map constructing module is configured for obtaining the position information of the members in the designated virtual group from the storage according to the request, and constructing a positional map according to the position information. The transmitting module is further configured for transmitting the positional map to the terminal devices of the members in the designated virtual group.

Other advantages and novel features of the present invention will become more apparent from the following detailed description of exemplary embodiments when taken in conjunction with the accompanying drawings.

### BRIEF DESCRIPTION OF THE DRAWINGS

FIG. 1 is a schematic diagram illustrating a hardware configuration of a system installed in a server for locating positions of members of virtual groups in accordance with an exemplary embodiment.

FIG. 2 is a functional block diagram of the system of FIG. 1.

FIG. 3 is a functional block diagram of each terminal device of FIG. 1.

FIG. 4 is a flow chart illustrating a method for locating positions of members of virtual groups in accordance with an exemplary embodiment.

FIG. 5 is a schematic diagram illustrating a positional map created by the system of FIG. 1.

FIG. 6 is a table illustrating a listing of position statistics generated by the system of FIG. 1.

FIG. 7 is a table illustrating a listing of position coordinates created by the system of FIG. 1.

### DETAILED DESCRIPTION OF THE EMBODIMENTS

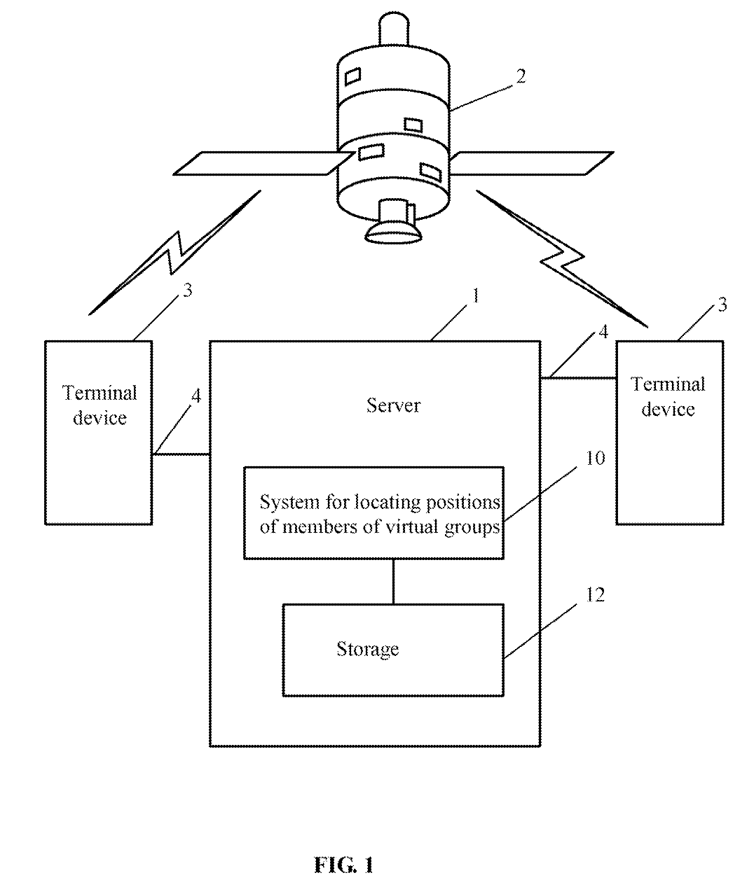

FIG. 1 is a schematic diagram illustrating a hardware configuration of a system installed in a server for locating positions of members of virtual groups (hereinafter, “the system”) in accordance with an exemplary embodiment. The system 10 is installed and run in a server 1, which is connected with a plurality of terminal devices 3 through a communication network 4. Each of the terminal devices 3 communicates with a telecommunication satellite 2. The system 10 is configured for collecting position information from the terminal devices 3, processing and analyzing the position information according to requests of users from the terminal devices 3, acquiring analysis data, and transmitting the analysis data to the terminal devices 3 for viewing by the users.

The server 1 further includes a storage 12, which is configured for storing various kinds of data that includes the requests of the users, personal data of the users, the position information, etc. The storage 1 2 may be divided into a plurality of sections for storing different kinds of data, such as a first section for storing the personal data of the users, a second section for storing the position information, and a third section for storing the analysis data, and so on.

The terminal devices 3 may be portable electronic devices, such as mobile phones, notebook, Palms, personal digital assistants (PDAs), and so on. In the exemplary embodiment, the terminal devices 3 are mobile phones, which may exchange data with the server 1 through the communication network 4. For example, if the communication network 4 is the Global System for Mobile communications (GSM), the terminal devices (i.e., the mobile phones) 3 and the server 1 may exchange data with each other by way of short message services (SMS). In the exemplary embodiment, each of the terminal devices 3 and the server 1 has a special SMS number respectively. For example, if the user needs to transmit relevant data to the server 1, the user may send a message to the SMS number of the server 1 from one of the terminal devices 3, and the server 1 also may send a message to the SMS number of the terminal device 3 to response the user.

Each of the terminal devices 3 receives signals from the telecommunication satellite 2 via a Global Position System (GPS) receiver installed in the terminal device 3. The received signals may include the position information and time information of users. In the exemplary embodiment, the position information and the time information are acquired by communicating with the telecommunication satellite 2. In other embodiments, the position information and the time information may be acquired by other technologies, such as a technology of trilateration.

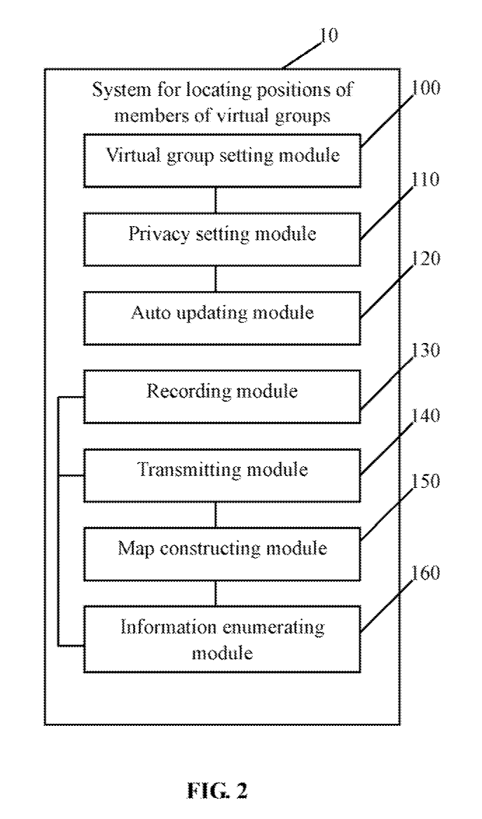

FIG. 2 is a functional block diagram of the system of FIG. 1. The system 10 typically includes a virtual group setting module 100, a privacy setting module 110, an auto updating module 120, a recording module 130, a transmitting module 140, a map constructing module 150, and an information enumerating module 160.

The virtual group setting module 100 is configured for establishing multiple virtual groups according to user demands, and naming the virtual groups. The virtual groups also may be called special interest groups (SIG) and comprise a plurality of members. In the exemplary embodiment, members are human users; but in other embodiments, the members may be other than humans. For example, the virtual group setting module 100 may establish a virtual group according to a common interest of a group of users such as footballers, and the group of users may wish to exchange information such as the location of a football stadium or meeting places, etc.

The virtual group setting module 100 is also configured for prompting the users to input their personal data into the system 10. The users may send requests for joining in one or more virtual groups or establishing new virtual group(s), from the terminal devices 3 to the server 1. For example, the user may establish a family virtual group for acquiring position information of family members in a family virtual group in real time. After joining in the virtual group successfully, the user becomes one member of the virtual group. In the exemplary embodiment, all members in the same virtual group may share their position information.

The virtual group setting module 100 is further configured for allocating an identity number to each member in the virtual groups. In the exemplary embodiment, if the member communicates with the system 10 by utilizing the mobile phone, the virtual group setting module 100 further records a telephone number of the mobile phone, and relating the identity number, the telephone number with the personal data of the member.

The privacy setting module 110 is configured for providing multiple privacy settings to allow the member to restrict or control access to private data by other members. The privacy settings may include public, normal, and private types. Detailedly, the public type allows open access to all personal data of the member; the normal type allows the member to selectively shield a portion of their personal data; and the privacy type blocks access to all personal data. For example, the member may allow sharing his/her name and identity number with the members in the same virtual group, and hide his/her telephone number using the normal type.

The auto updating module 120 is configured for acquiring position information of each member in each virtual group, and updating the storage 12 periodically according to the position information.

The recording module 130 is configured for recording positions the members have visited and wished to remember or share with other members in the same virtual group. The recorded position information can include the date and time the member was there and any special comments of the member. The recording module 130 is further configured for counting and acquiring position and time statistics of the recorded position information.

The transmitting module 140 is configured for receiving different requests of the users from the terminal devices 3, such as a request for viewing position information of the members in the same virtual group as the user, a request for querying a position of a fixed position, such as a specific restaurant, a route to the restaurant, and so on.

In the exemplary embodiment, the position information includes historical data and real time data. The historical data includes the position statistics of the recorded positions, which includes the time information and the comments. According to the historical data, the users may find out which positions are most reached by the other members in the same virtual group. For example, one member in a “football lovers” virtual group records different playing fields for playing football and comments on the playing fields, thus the members in the “football lovers” virtual group may view where they can play football and which playground is the best one according to the comments.

The real time data includes current positions of each member in the same virtual group. For example, if the user wants to go to a party with the members in the same virtual group, the user may acquire the current positions of the members by sending the requests for acquiring the real time data to the server 1 from the terminal devices (i.e., the mobile phones) 3, instead of calling the other members and asking where they are.

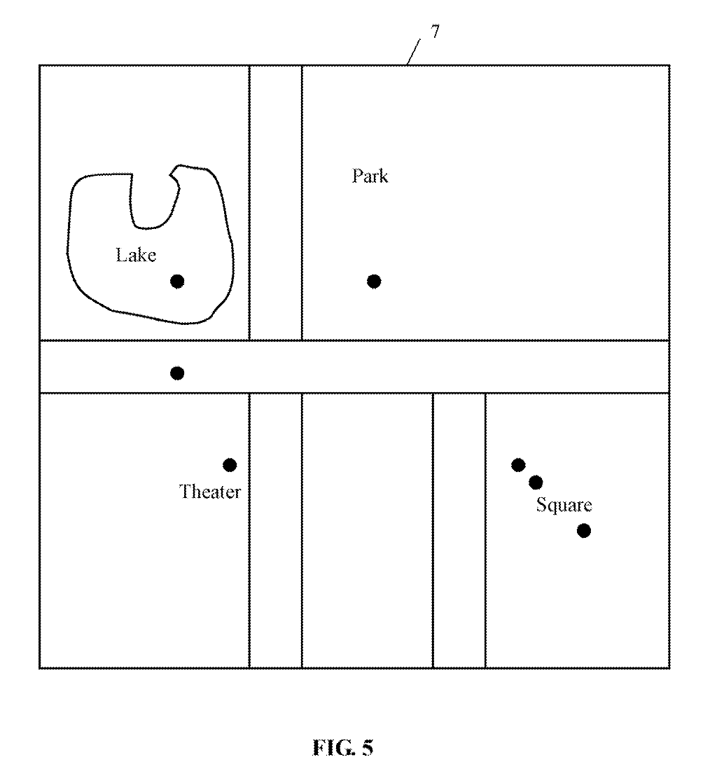

The map constructing module 150 is configured for obtaining position information of the members in the same virtual group from the storage 12 according to the request, and constructing a positional map according to the obtained position information. On the positional map, the position of each members in the same virtual group is marked, such as with a bright spot or a dark spot by the map constructing module 150. The map constructing module 150 may further indicate the identity number of each member beside each members mark, thus it is easy for the members to quickly find and identify other members. For instance, FIG. 5 shows a distribution of members in a special virtual group.

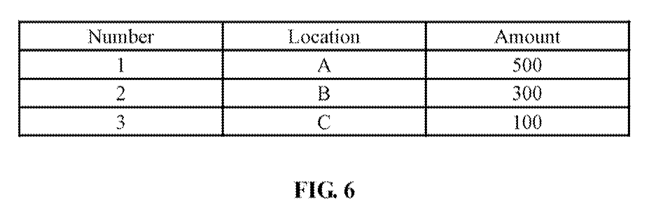

The information enumerating module 160 is configured for analyzing various kinds of data in the storage 12, such as the position information of the members in the virtual group, the personal data of each member, and so on. The information enumerating module 160 is further configured for presetting the formats of listings, and enumerating analysis data in the listings according to the current preset format. A listing is shown in FIG. 6. The number of members who have ever visited position A is counted. The members may get to know which positions are most visited by the members in the same virtual group through the listings.

The map constructing module 150 constructs the positional map, and then the information enumerating module 160 enumerates the analysis data in the listings according to the privacy settings confirmed by the users. For example, if the user refuses to share his/her position with other members in the same virtual group, the positional map does not show his/her position. For another example, if the user is not willing to publish his/her name, the mobile phone number, or other personal data, the listings may not show these things.

The transmitting module 140 is further configured for transmitting the positional map and the listings to each of the terminal devices 3 for sharing with the other members in the same virtual group.

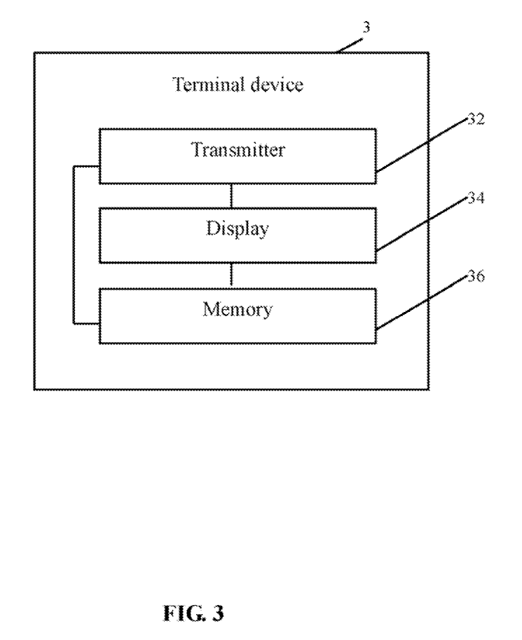

FIG. 3 is a functional block diagram of each terminal device of FIG. 1. The terminal devices (i.e., the mobile phones) 3 provide an interface for the users to perform relevant operations. Each of the terminal devices 3 includes a transmitter 32, a display 34, and a memory 36.

The transmitter 32 is configured for transmitting the request of the user from one of the terminal devices 3 to the server 1, and then receiving corresponding data from the server 1, such as the positional map, the listing, etc. The display 34 may be a liquid crystal display (LCD), and is configured for displaying corresponding data received from the server 1. The memory 36 is configured for storing various data transmitted to the server 1 or received from the server 1.

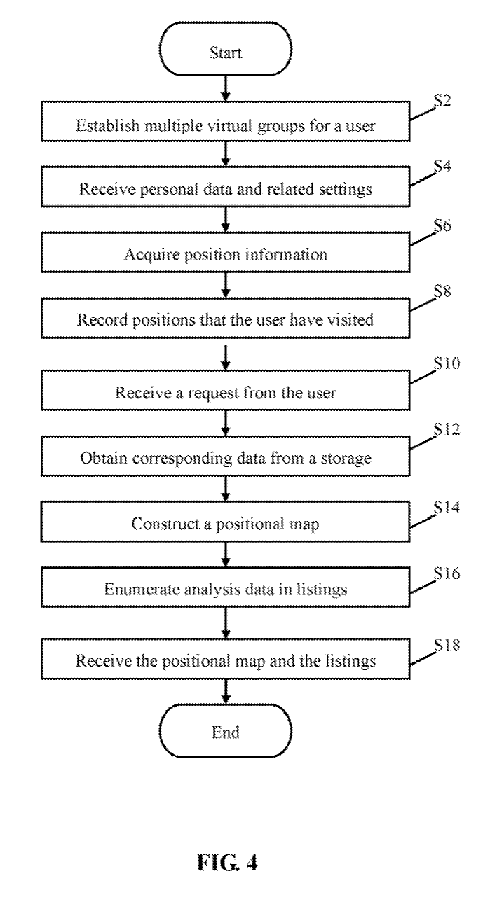

FIG. 4 is a flow chart illustrating a method for locating positions of members in virtual groups in accordance with an exemplary embodiment. In step S2, the virtual group setting module 100 establishes multiple virtual groups according to the user demands, and names the virtual groups. The users may send requests for joining in one or more established virtual groups or establishing new virtual group(s), from the terminal devices 3 to the server 1.

In step S4, the virtual group setting module 100 prompts the users to input their personal data into the system 10, and the privacy setting module 110 providing multiple privacy settings to allow the user to restrict or control access to private data by other members in the same virtual group as the user. The types of privacy settings may include public, normal, and private types.

In step S6, the auto updating module 120 acquires the position information of each member in the virtual groups, and updates the storage 12 periodically according to the position information.

In step S8, the recording module 130 records recording positions the members have visited and wished to remember or share with other members in the same virtual group. The recorded position information includes the time the member was there and any special comments of the member. The recorded position information may be viewed by the other members in the same virtual group as the user. The recording module 130 may further count and acquire position and time statistics of the recorded position information.

In step S10, the transmitting module 140 receives a request of the user from one of the terminal devices 3, in the exemplary embodiment, the request is to view the position information of the other members in the same virtual group as the user. In other embodiments, the request may be to view the position of the fixed position, such as a specific restaurant, and the route to the restaurant etc.

In step S12, the map constructing module 150 obtains the position information of the other members in the same virtual group from the storage 12 according to the request for viewing position information of the other members in the same virtual group.

In step S14, the map constructing module 150 constructs the positional map according to the obtained position information.

In step S16, the information enumerating module 160 analyzes the position information of the members in the same virtual group, the personal data of each member, and other relevant data in the storage 12, and enumerates the analysis data in the listings according to a preset format.

In step S18, the transmitting module 140 sends the positional map and the listings to the terminal devices 3, the transmitter 32 receives the positional map and the listing from the server 1, and the display 34 displays the positional map and the listings.

FIG. 5 is a schematic diagram illustrating a positional map created by the system of FIG. 1. The positional map 7 shows where the members in the same virtual group are.

FIG. 6 is a table illustrating a listing of position statistics generated by the system of FIG. 1. The position statistics refer to the positions recorded by each member in the same virtual group. As shown in the listing of the position statistics, the number of members who visited positions A, B, and C are shown.

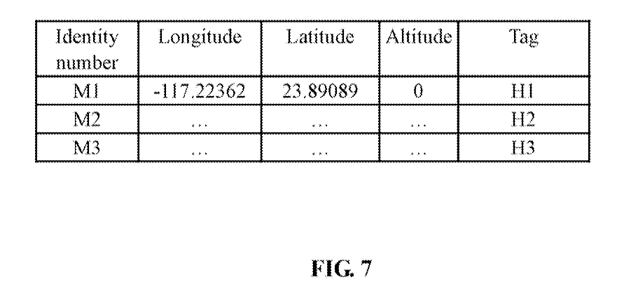

FIG. 7 is a table illustrating a listing of position coordinates created by the system of FIG. 1. In the listing of position coordinates, the identity number and the position coordinates of each member are shown. The position coordinates include longitude, latitude, and altitude. The recording module 130 marks position coordinates of the members with different tags. For example, a member of the virtual group having an identity number of “M1” is at a position having longitude “−117.22362,” latitude “23.89.89,” and altitude “0” (sea level). A positional map (not shown) may be constructed according to the position coordinates of each member. In the positional map, the member “M1” is represented as a bright spot having a tag of “H1” for example.

As previously stated the members may be other than human users. For example, members could be vehicles equipped with GPS in a taxi fleet. The information available could be used for real time assessment of fleet distribution and also analysis of historical data to determine when and where people are most likely to be at a given time or who may need a taxi. Obviously many other application environments would be suitable for the present system and method.

It should be emphasized that the above-described embodiments, particularly, any “preferred” embodiments, are merely possible examples of implementations, and set forth for a clear understanding of the principles of the invention. Many variations and modifications may be made to the above-described exemplary embodiment(s) without departing substantially from the spirit and principles of the invention. All such modifications and variations are intended to be included herein within the scope of this disclosure and the above-described exemplary embodiment(s), and the present invention is protected by the following claims.

What is claimed is:

1. A system for locating positions of members of virtual groups, the system being installed in a server connected with a plurality of terminal devices, the system comprising:
a virtual group setting module configured for establishing multiple virtual groups for a user to join in;
an auto updating module configured for acquiring position information of each member in each of the virtual groups, and storing the position information in a storage;
a transmitting module configured for receiving requests for viewing position information of members in a designated virtual group from the terminal devices;
a map constructing module configured for obtaining the position information of the members in the designated virtual group from the storage according to the requests, and constructing a positional map according to the position information; and
the transmitting module further configured for transmitting the positional map to the terminal device of the members in the designated virtual group.

2. The system as claimed in claim 1, further comprising a recording module configured for recording positions information that the members have visited and wished to remember or share with other members in the same virtual group, wherein the recorded position information comprises when the members were there and any special comments of the members.

3. The system as claimed in claim 2, wherein the recording module is further configured for counting and acquiring position and time statistics of the recorded position information.

4. The system as claimed in claim 1, further comprising an information enumerating module configured for analyzing the position information of the members in the designated virtual group, and enumerating analysis data in listings with different formats.

5. The system as claimed in claim 1, further comprising a privacy setting module configured for providing multiple types of privacy settings for each member to allow the member to restrict or control access to private data by other members.

6. The system as claimed in claim 1, wherein the auto updating module is further configured for updating the storage periodically by acquiring the position information of each member in each of the virtual groups.

7. The system as claimed in claim 1, wherein the storage is further configured for storing settings of each of the virtual groups and the privacy settings of each user.

8. The system as claimed in claim 1, wherein the position information of each member in each of the virtual groups comprises historical data that comprises position statistics of each member ever reaches, and real time data that comprises a current position of each member.

9. The system as claimed in claim 1, wherein the terminal device is configured for receiving, displaying and storing the positional map.

10. A computer-implemented method for locating positions of members of virtual groups, the method comprising:
establishing multiple virtual groups for a user to join in;
acquiring position information of each member in each of the virtual groups;
storing the position information of each member in each of the virtual groups in a storage;
receiving requests for viewing position information of members in a designated virtual group from terminal devices;
obtaining the position information of the members in the designated virtual group from the storage according to the requests, and constructing a positional map according to the position information; and
transmitting the positional map to the terminal devices of the members in the designated virtual group.

11. The method according to claim 10, further comprising:
recording positions information that the members have visited and wished to remember or share with other members in the same virtual group, wherein the recorded position information comprises when the members were there and any special comments of the member.

12. The method according to claim 11, further comprising:
counting and acquiring position and time statistics of the recorded position information.

13. The method according to claim 10, further comprising:
analyzing the position information of the members in the designated virtual group, and enumerating analysis data in listings with different formats.

14. The method according to claim 10, further comprising:
providing multiple types of privacy settings for each member to allow the member to restrict or control access to private data by other members.

15. The method according to claim 10, wherein the acquiring step comprises:
updating the storage periodically by acquiring the position information of each member in each of the virtual groups.

16. The method according to claim 10, wherein the storing step comprises:
storing settings of each of the virtual groups and the privacy settings of each user into the storage.

17. The method according to claim 10, wherein the position information of each member in each of the virtual groups comprises historical data that comprises position statistics that the members have visited, and real time data that comprises a current position of each member.

18. The method according to claim 10, further comprising:
receiving, displaying and storing the positional map through the terminal device.
